(19) United States
(12) Patent Application Publication
(10) Pub. No.: US 2011/0196627 A1
(43) Pub. Date: Aug. 11, 2011

(54) METHOD AND DEVICE FOR EVALUATING AN ELECTRICAL INSTALLATION OF AN ELECTRICAL POWER SYSTEM

(76) Inventors: Fred Steinhauser, Klaus (AT); Cristian Marinescu, Dornbirn (AT)

(21) Appl. No.: 13/014,312

(22) Filed: Jan. 26, 2011

(30) Foreign Application Priority Data
Feb. 5, 2010 (EP) EP 10 001 233.5
Jun. 22, 2010 (EP) EP 10 006 494.8

(51) Int. Cl. G06F 19/00; G01R 31/02

(52) U.S. Cl. 702/58

(57) ABSTRACT

The present invention relates to a method for evaluating an electrical installation (1981-2211) of an electrical power system (1000, 1600). The electrical installation (1981-2211) comprises a communication network (2111, 2211) for transmitting data. In the method, real-time data transmissions in the communication network (2111, 2211) are detected automatically and the electrical installation (1981-2211) is evaluated automatically on the basis of the detected real-time data transmissions. The behaviour of a sampling unit, of a merging unit or of an SV transmitter (7) is further evaluated automatically on the basis of the detected real-time transmissions.

The present invention relates to a method and a device for evaluating an electrical installation of an electrical power system. The present invention relates in particular to electrical installations in which real-time data, for example sampled values, according to IEC 61850, are transmitted in a communication network, and therefore in particular to a method and a device for evaluating the communication network and its components.

### BACKGROUND OF THE INVENTION

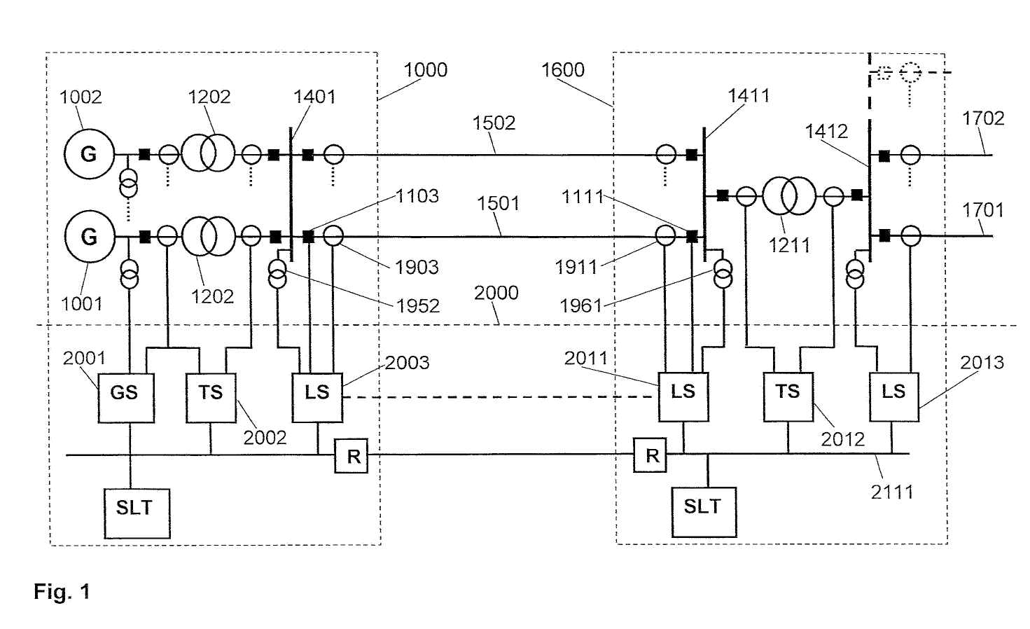

FIG. 1 shows, in diagrammatic and highly simplified form, fundamental elements of an exemplary sub-system of an electrical power system. The electrical power flows in FIG. 1 from left to right, from a power plant 1000, a so-called “power station”, via high-voltage transmission lines 1501, 1502 to a transformer plant 1600, a so-called “transformer station”. The electrical power is produced in generators 1001 and 1002 and transformed to high voltage in output transformers 1201 and 1202. Such output transformers associated with a generator are also called unit transformers or generator transformers. The power is passed from the unit transformers 1201, 1202 to a bus-bar 1401, from where it is distributed further on high-voltage transmission lines 1501, 1502. The high-voltage transmission line 1501, 1502 is here in the form of a double line. In practice, such a double line is in most cases guided jointly on a mast system. The rated currents at high voltage level are in the range from several hundred to several thousand amperes, the rated voltages range from several tens of thousands up to one million volts. In the transformer plant 1600, the incoming lines 1501, 1502 are again combined at a bus-bar 1411. The electrical power present at the bus-bar 1411 is transformed to a different voltage level by an output transformer 1211 and delivered to a bus-bar 1412. From the bus-bar 1412, the power is distributed further via lines 1701, 1702. FIG. 1 shows a so-called single-line equivalent circuit diagram. However, the electrical power system is conventionally a three-phase system. Accordingly, the elements shown represent three-phase forms; for example, the line 1501 shown as one line in reality consists of three cables.

The production, transmission and distribution of the electrical power accordingly takes place in the so-called primary elements described above, that is to say the primary elements guide the primary currents and primary voltages, which together are referred to as primary parameters. The primary elements together are also referred to as the primary system. Parallel to the primary system there is a further, so-called secondary system, which consists of protection and control devices. The elements above a symbolic dividing line 2000 in FIG. 1 belong to the primary system, while the elements below the dividing line 2000 belong to the secondary protection and control system. Transformers 1903, 1911, 1952, 1961 occupy an intermediate position. They are connected, on the one hand, to the primary system and, on the other hand, to the secondary system and accordingly cannot be classified unequivocally.

Below the dividing line 2000, various protection devices are shown, for example a generator protection system (GS) 2001, a transformer differential protection system (TS) 2002, 2012 and a line protection system (LS) 2003, 2011, 2013. Only protection devices are shown in FIG. 1 in order to maintain clarity; control devices would be arranged at the same level. The protection and control devices cannot be connected directly to the high-voltage-carrying primary elements in order to acquire information about the parameters in the primary system. The transformers therefore deliver standardised images of the primary parameters, the so-called secondary parameters, to the protection and control devices. The ratios of the current transformers, e.g. 1903, 1911, are such that they deliver secondary currents of 1 A or 5 A when rated current is flowing in the primary system. The voltage transformers, e.g. 1952, 1961, deliver a secondary voltage of 100 V (in some parts of the world also 110 V, 115 V, 120 V) with rated voltage in the primary system.

Further elements of the primary system are also operated via the protection and control devices. In particular, when a fault is identified, the protection devices can activate circuit breakers, for example, and thus interrupt the current flow. In FIG. 1, this is shown by way of example for the two line protection devices 2003 and 2011 and their associated circuit breakers 1103 and 1111. The circuit breakers 1103, 1111 can interrupt the current flow through the primary elements. This is also true in particular in the case of a fault, when fault currents flow that exceed the normal operating currents by a multiple. Isolation switches, which are likewise present in real installations, are not shown. These are generally arranged with the circuit breakers and serve to produce isolating distances which are sufficiently great safely to isolate individual installation parts from live installation parts. The position of such isolation switches is clearly identifiable for the operating personnel so that work can safely be carried out on disconnected installation parts. Such isolation switches are not capable of interrupting a current flow, either a normal operating current or a fault current. Accordingly, an isolation switch must only be operated when the corresponding circuit breaker has interrupted the current flow, that is to say when it is open.

The protection devices evaluate the currents and voltages and, where appropriate, also further information from the primary and secondary system and determine whether a normal operating state or a fault is present. In the event of a fault, an installation part identified as being faulty is to be disconnected as quickly as possible by activating the corresponding circuit breakers. The protection devices are specialised for different tasks. The generator protection system 2001, as well as evaluating the currents and voltages at the generator, also evaluates many further parameters. The transformer differential protection system 2002, 2012 applies Kirchhoff's nodal rule to the currents at the output transformer 1201, 1211. The line protection system 2003, 2011, 2013 examines currents and voltages at the line ends and carries out an impedance measurement, for example. A bus-bar protection system, which can be used to protect the bus-bars 1401, 1411, 1412, is not shown. The bus-bar protection system applies Kirchhoff's nodal rule to the currents flowing into and out of the bus-bar. Many protection devices nowadays are multifunctional, that is to say they can incorporate a plurality of protection functions and, in particular, can also carry out control functions (combined protection and control devices).

In FIG. 1, information is obtained from the primary system and the primary system is influenced via the so-called conventional interfaces. These are analogue measured parameters and direct-wired binary information, that is to say the secondary parameters from the transformers, switch statuses of signal contacts or operating energies for actuators.

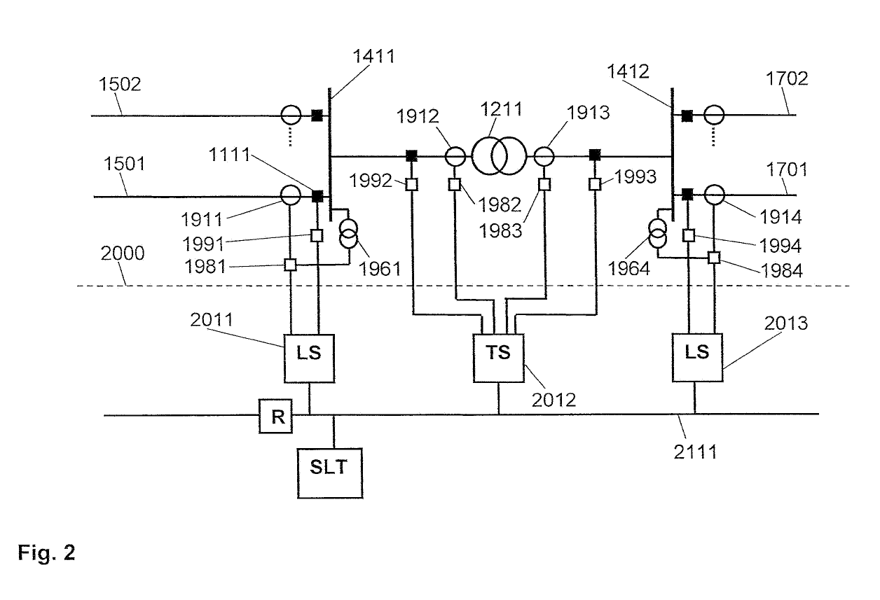

In a more recent system, as is shown by way of example in FIG. 2, the conventional interfaces, that is to say the secondary parameters and the direct-wired connections between the protection devices and primary elements, have been replaced. To that end, so-called intelligent electronic devices (IEDs) 1981-1984, 1991-1994 which, on the one hand, have access to the primary parameters and, on the other hand, communicate with the protection and control devices via network protocols are connected as directly as possible to the primary elements. FIG. 2 shows such an architecture for the switching system 1600 of FIG. 1. So-called merging units 1981-1984 digitise the measured values from the current and voltage sensors 1911-1914, 1961, 1964 and make them available to the protection devices as sampled values via a network interface. The sensors can be based on any desired physical principles. A standardised protocol between the merging unit and the protection device establishes interoperability. The sampled values can be, for example, sampled values according to standard IEC 61850 or according to the implementation guideline “Implementation Guideline for Digital Interface to Instrument Transformers using IEC 61850-9-2”. The intelligent control units 1991-1994 detect statuses of the primary elements and operate actuators in the primary elements. FIG. 2 shows, by way of example, circuit breaker control devices in which the detected statuses are the switch setting and, for example, the instantaneous breaking capacity and the operated actuators are the trip coils and the switch drives. In order to transmit detected statuses to the protection and control devices or to receive commands from the protection and control devices, the intelligent control units likewise use protocols via network interfaces. Event-driven telegrams, whose information content is updated and transmitted only when the statuses and commands change, are suitable for the exchange of such information. Such event-driven telegrams can be, for example, so-called GOOSE messages according to standard IEC 61850.

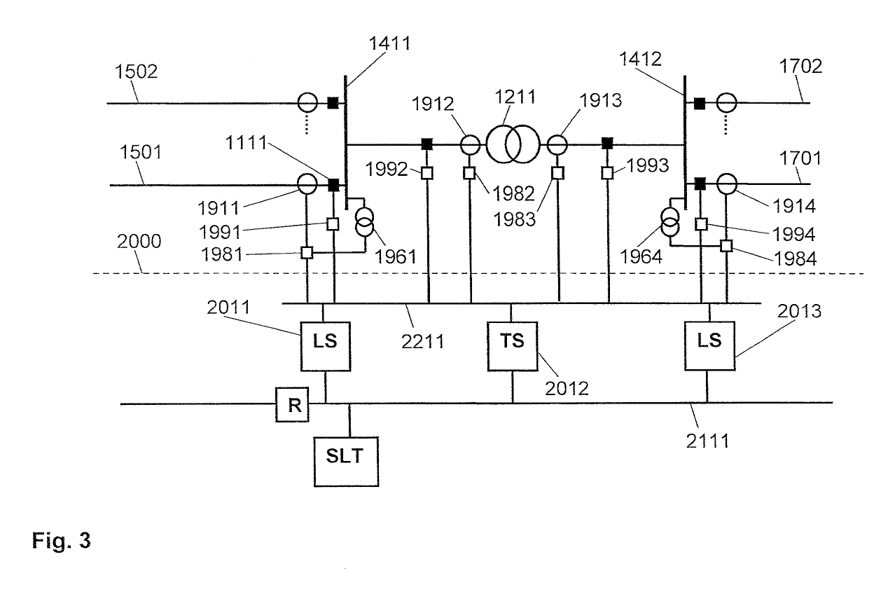

While in FIG. 2 information is exchanged between the merging units 1981-1984 and the intelligent control units 1991-1994, on the one hand, and the protection and control devices 2011-2013, on the other hand, via point-to-point connections, FIG. 3 shows an architecture in which the information is collected and distributed via a further network 2211. The network 2211 is also called a “process bus”, while a network 2111 is often also called a “station bus”. The distinction between these networks (buses) and the nature of the exchanged information are not always entirely sharp and unequivocal. Thus, event-driven messages (GOOSE messages) can likewise expediently be used at the station bus, even in architectures according to FIG. 1. It is even possible for the process bus and the station bus to be merged in one physical network if the data traffic can be managed. In any event, more meaningful communication relationships are given by the network 2211 than can be established by the point-to-point connections of FIG. 2. New applications for protection and control functions are accordingly made possible. For example, the transformer protection system 2012 could examine the voltages at the bus-bars 1411 and 1412 via the sampled values from the merging units 1981 and 1984 and make the connection of the transformer 1211 dependent on their mutual phasing.

The standard “Communication networks and systems in substations—Part 9-2: Specific Communication Service Mapping (SCSM)—Sampled values over ISO/IEC 8802-3” (IEC61850-9-3) supplements part 7-2 of standard IEC 61850 with the corresponding mapping of the sampled value model and is used in the field of electric current and voltage transformers with a digital output, merging units (MUs) or IEDs (intelligent electronic devices) such as, for example, protection devices, bay control units or meters. As part of the specification of communication at the process bus 2211, the standard defines the mapping of the sampled value model (such as e.g. instantaneous values of currents and voltages in the form of network packets) and permits interoperability between devices from different manufacturers. The guideline “Implementation Guideline for Digital Interface to Instrument Transformers using IEC 61850-9-2” (also known by the abbreviation 9-2LE) specifies how a digital communication interface according to IEC 61850-9-2 must be implemented in order to support the dissemination of the standard and of the IEC 61850-9-2 implementations in products. The document specifies a subset of all the possibilities allowed by the standard and clarifies uncertainties which might be caused by the interpretation of the standard. The subset of IEC 61850 defined in the guideline supports only the function SendMSVMessage. For that reason, communication is unidirectional from the MU to the field devices and does not have to support any further control interface. The document further defines the logical device “merging unit”. The guideline specifies 80 samples per period for 50 Hz and 60 Hz (4000 or 4800 packets per second), which corresponds to a packet every 250 μs or 208.33 μs. An important test is the check of the time distribution of the packets; if the maximum time limit is exceeded, this must be evaluated as a fault (e.g. if 9-2LE specifies a maximum limit of 3.3 ms). A synchronised mode defines the sampling frequency within the second so that the packet having the index 0 should always be sent at the start of the second. The accuracy of the synchronisation is set at 4 μs.

For the reliable and high-performance operation of installations as described in FIGS. 1 to 3, it is therefore necessary for certain performance values of the communication, that is to say of the devices involved and the connection between them (of the communication network), to be ensured and verified. For example, when implementing an IEC 61850-9-2 capable electrical installation, it is necessary to assess the quality or time behaviour of the incorporated MUs or of the data streams of sampled values (SVs) in the network. There are at present no methods of checking a time behaviour of an MU as specified in the guideline or the quality of an SV stream. Furthermore, there is no measuring process for evaluating the quality or synchronisation of an SV data stream.

It is an object of the present invention, therefore, to provide methods and devices which allow the quality or time behaviour of real-time data in a communication network of an electrical installation to be assessed and a network architecture to be assessed.

The object is achieved according to the invention by a method for evaluating an electrical installation of an electrical power system according to claim 1 and a device for evaluating an electrical installation of an electrical power system according to claim 15. The dependent claims define preferred and advantageous embodiments of the invention.

According to the present invention, a method for evaluating an electrical installation of an electrical power system is provided. The electrical installation comprises a communication network for transmitting data. In the method, real-time data transmissions in the communication network are detected automatically and the electrical installation is evaluated automatically on the basis of the detected real-time data transmissions.

By means of the automatic detection of the real-time data transmissions in the communication network, a sequence of transmitted data, for example, can be analysed and it can be determined therefrom, for example, whether data are missing, that is to say whether data have been lost in the communication network.

According to an embodiment, time-related information is automatically assigned to each of the detected real-time data transmissions. The communication network of the electrical installation can accordingly additionally be evaluated automatically on the basis of the time-related information of the detected real-time data transmissions. For example, a statistical distribution of the real-time data transmissions can be determined automatically on the basis of their time-related information in order to acquire information about the communication network load. Furthermore, the real-time data transmissions can in each case be detected automatically in at least two different locations of the communication network. It can thus be determined, for example, in which sections of the communication network real-time data transmissions are being lost or delays in real-time data transmission are occurring. Furthermore, a time interval between successive real-time data transmissions can be detected, for example, from which a load and capacity of the architecture of the communication network can be determined.

According to an embodiment, a sampling unit of the electrical installation forms a real-time sampled value by sampling an electrical parameter of the electrical power system. The sampling unit transmits the real-time sampled value as a real-time data transmission via the communication network. Time-related information can automatically be assigned to each of the detected real-time data transmissions on leaving the sampling unit. Accordingly, the sampling unit of the electrical installation can be evaluated automatically on the basis of the time-related information of the detected real-time data transmissions. For example, missing real-time data transmissions can be identified or it can be established whether a time interval between successive real-time data transmissions exceeds a defined upper limit. Furthermore, a statistical distribution of the real-time data transmissions can be determined and the quality of the stream of real-time data transmissions of the sampling unit can be determined therefrom.

According to a further embodiment, the sampling unit comprises a merging unit which is arranged to sample a plurality of real-time sampled values of a plurality of electrical parameters of the electrical power system and transmit them as a real-time data transmission via the communication network. The merging unit can comprise, for example, a so-called merging unit according to IEC 61850. As described hereinbefore in connection with the evaluation of the quality of the sampling unit, the quality of the merging unit can likewise be determined in that manner. Moreover, the quality of a transmitting device (a so-called SV transmitter) of the sampling unit or of the merging unit, which outputs the sampled values to the communication network, can be evaluated automatically.

According to an embodiment, the transmitted real-time data transmissions are detected by a network access device. The network access device and the sampling unit are synchronised with a common time source, and the network access device assigns time-related information to each of the real-time data transmissions. A time interval between the sampling time of an analogue value of the electrical installation and a transmission time at which the sampling unit transmits a corresponding real-time data transmission can thereby be determined. That time is, strictly speaking, the time of receipt in the network access device. However, with a suitable design of the measuring arrangement, the transmission time and the time of receipt are virtually identical. It is thereby possible, for example, to evaluate the quality of a sampling unit, of a merging unit, or of the synchronisation of the sampling unit or of the merging unit.

According to a further embodiment, a reference signal which comprises reference time-related information is provided. The reference time-related information appears as defined phasing in the case of sinusoidal parameters or as the exact time of a change in the reference signal in the case of non-sinusoidal parameters. The sampling unit samples the reference signal and transmits the corresponding real-time sampled values as real-time data transmissions via the communication network. The electrical installation is evaluated automatically on the basis of a comparison of the reference time-related information with the time-related information of the real-time data transmission. The time synchronisation of the sampling unit or of the merging unit can thereby be evaluated.

According to a further embodiment, the reference signal additionally comprises a reference value. By comparing real-time sampled values of the real-time data transmissions with the reference value it is possible automatically to evaluate the electrical installation, in particular the transformer accuracy of the sampling unit or of the merging unit.

The reference signal can be provided, for example, by a protection tester which simulates an ideal sampling unit and which is synchronised with the time source with which the sampling unit or the merging unit is synchronised. By comparing the transmitted real-time data transmissions with reference outputs of the protection tester, which provides accurate time-related information and parameter information of the reference signal, it is possible to evaluate the transformer accuracy of the sampling unit or of the merging unit, the transformer speed of the sampling unit or of the merging unit and the rate of transmission of the communication network.

According to a further aspect of the present invention, a device for evaluating an electrical installation of an electrical power system is provided. The electrical installation comprises a communication network for transmitting data. The device comprises a network access device and an evaluation device. The network access device can be coupled with the communication network and is arranged to detect real-time data transmissions in the communication network. The evaluation device is provided with the real-time data transmissions by the network access device. The evaluation device is arranged to evaluate the electrical installation on the basis of the real-time data transmissions.

The electrical installation comprises, for example, one or more sampling units which are arranged to form real-time sampled values by sampling an electrical parameter of the electrical power system and to transmit them as real-time data transmissions via the communication network.

The sampling unit can further comprise a merging unit which is arranged to sample a plurality of real-time sampled values of a plurality of electrical parameters of the electrical power system and to transmit them as real-time data transmissions via the communication network. The merging unit can comprise, for example, a merging unit according to IEC 61850. The real-time data transmissions can comprise, for example, so-called “sampled values” according to IEC 61850. The device can further comprise a time source which is suitable for synchronising the sampling unit and the network access device. By synchronising the sampling unit and the network access device, the quality of the sampling unit or of the merging unit can be evaluated by, for example, calculating a time interval between successive real-time data transmissions and determining a statistical distribution of the real-time data transmissions.

According to an embodiment, the device comprises a protection tester which is capable of providing a reference signal comprising a reference value having associated reference time-related information. The sampling unit samples the reference signal and transmits the corresponding real-time sampled value as a real-time data transmission via the communication network. The electrical installation is evaluated automatically by comparing the reference time-related information with the time-related information of the real-time data transmission.

According to a further embodiment, the protection tester simulates an ideal sampling unit. The protection tester and the sampling unit are synchronised with the time source.

The device can further be so arranged that it is suitable for carrying out the above-described method and its embodiments. Therefore, the device also has the above-described advantages of the above-described method and its embodiments.

The present invention is explained hereinbelow by means of preferred embodiments with reference to the drawings.

FIG. 1 shows, in diagrammatic form, elements of an exemplary sub-system of an electrical power system according to the prior art.

FIG. 2 shows, in diagrammatic form, a further exemplary sub-system of an electrical power system according to the prior art.

FIG. 3 shows, in diagrammatic form, yet a further exemplary sub-system of an electrical power system according to the prior art.

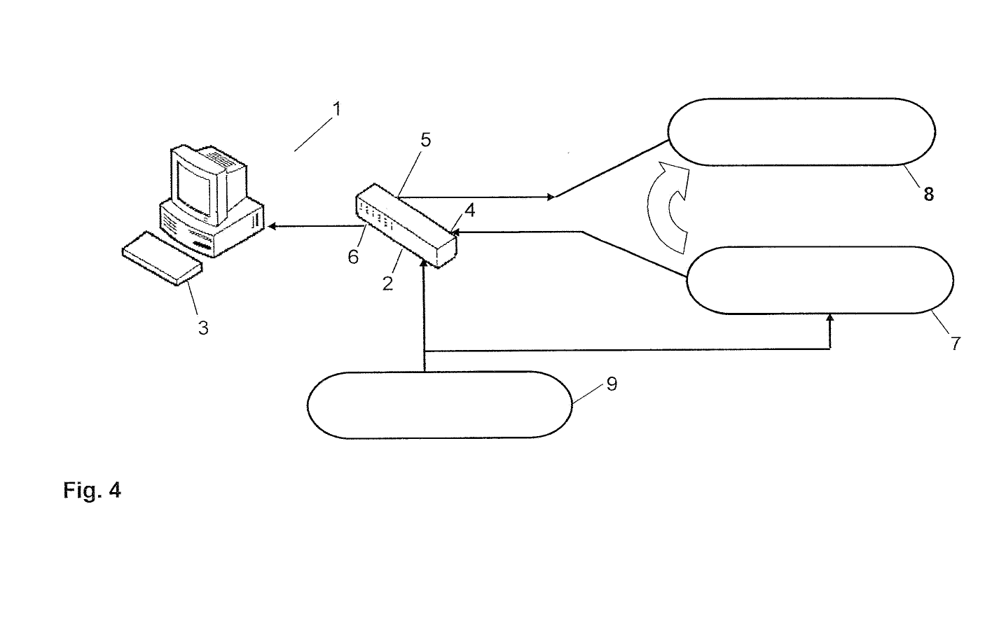

FIG. 4 shows a device for evaluating an electrical installation of an electrical power system according to an embodiment of the present invention.

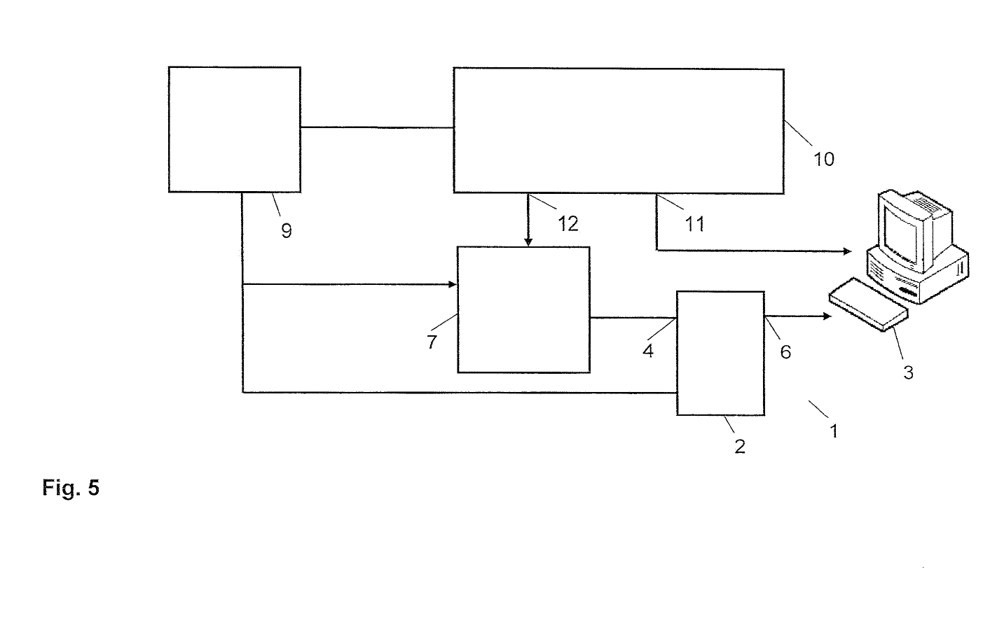

FIG. 5 shows a further embodiment of a device for evaluating an electrical installation of an electrical power system according to the present invention.

FIG. 4 shows a device 1 for evaluating an electrical installation of an electrical power system as shown, for example, in FIG. 3. The device 1 comprises a network access device 2 and an evaluation device 3. The evaluation device 3 is, for example, a computer with suitable analysis and evaluation software. For evaluating the electrical installation of the electrical power system, in particular for evaluating a communication infrastructure and individual components of the communication infrastructure, the network access device 2 is coupled with the electrical installation of the electrical power system. The network access device 2 is also called the network access point or network TAP (test access port). The network TAP is a piece of hardware which allows network traffic between two or more network nodes to be observed. The network TAP usually has at least three connections 4-6. In order to observe network traffic between two network nodes 7 and 8, for example a network cable between the network node 7 and the network node 8 is replaced by the network TAP 2 and two new network cables, the network TAP thereby being looped into the connection between the network node 7 and the network node 8. To that end, the network node 7 is coupled by means of a network cable with the connection 4 of the network TAP 2, and the network node 8 is coupled by means of a network cable with the connection 5 of the network TAP 2. Accordingly, all the network traffic from the network node 7 to the network node 8 and vice versa is transmitted via the network TAP 2 without affecting the network traffic. Moreover, all the network traffic from the connections 4 and 5 is additionally outputted to the connection 6, a so-called monitoring connection, from the network TAP 2 to the evaluation device 3. The network node 7 can be, for example, an intelligent electronic device (IED) or a merging unit (MU), as described hereinbefore in connection with FIGS. 2 and 3. The network node 7 accordingly provides, for example, sampled values in the form of sampled values (SVs) according to standard IEC 61850 as real-time data transmissions, so-called data packets. These data packets are transmitted via the network TAP 2 to the network node 8, which can comprise, for example, a protection or control device, which has been described in connection with FIGS. 2 and 3.

Components 7, 8 of the electrical installation, that is to say, for example, the intelligent electronic devices, the merging units, the protection devices and the control devices, are synchronised with a time source 9 via a time distribution protocol present in the electrical installation. The time distribution can take place, for example, according to IRIG-B, PPS or IEEE1588. In order to be able to provide the individual real-time data transmissions or data packets with a very accurate timestamp, the network TAP 2 is also coupled and synchronised with the time source 9. Synchronisation is effected, for example, with an accuracy of far below 1 μs. On receipt of a real-time data transmission, which comprises sampled values, for example, the real-time data transmission is provided with the timestamp and outputted from the network TAP 2 to the evaluation device 3. The evaluation device 3 then carries out an analysis and evaluation of the electrical installation, that is to say of the communication infrastructure between the network nodes 7 and 8, and an evaluation of the network nodes 7, 8 themselves.

For example, the quality of the SV data stream can be evaluated at an output of a merging unit or of an intelligent electronic device which transmits sampled values (SVs) by evaluating the time-related sequence of the data packets and their statistical distribution. By analysing the sequence of the packets it is possible, for example, to identify faults in the SV data stream, such as, for example, missing packets, or that a time interval between successive SV packets exceeds a defined upper limit. The evaluation device 3 can further calculate a statistical distribution of the packets and determine therefrom an evaluation of the quality of a merging unit or of an SV data stream. The suitability of the communication infrastructure in the electrical installation for the transmission of SV data can further be evaluated. For example, by detecting data packets at an output of a transmitter, such as, for example, the node point 7, and detection at the receiver, for example the node point 8, a time behaviour of an SV data stream in the network can be analysed and evaluated, whereby it is possible to analyse and evaluate the influence of a network architecture and a network infrastructure. By comparing the results at the two measuring points it is possible to identify, for example, an impairment of the quality of the SV data stream, for example a loss of data packets or a worsening of the statistical distribution of the SV data packets. Using this information, it is possible to establish whether the existing network infrastructure is suitable for transmitting the SV data streams.

By synchronising the network TAP 2 with the same time source 9 with which, for example, a sampling unit or a merging unit 7 is also synchronised, it is possible to determine a time interval between a sampling time of an analogue value by the network node 7 and a transmission time of a corresponding real-time data transmission. For example, a time difference between the start of a second and the sampling time of a value with index 0, as is defined in guideline 9-2LE, can be detected, whereby, for example, the synchronisation of the network nodes can be evaluated.

FIG. 5 shows a further device 1 for evaluating an electrical installation of an electrical power system. The device 1 of FIG. 5, like the device 1 of FIG. 4, comprises the network TAP 2 and the evaluation device 3. The network TAP 2 is coupled with a merging unit 7, which provides the network TAP 2 with sampled values (SVs) via the connection 4. The merging unit 7 and the network TAP 2 are synchronised with the time source 9. The device 1 further comprises a protection tester 10 which comprises a three-phase current/voltage generator. The protection tester 10 is arranged to output analogue currents and voltages via a connection 12 and to output corresponding digital values in a synchronised manner in the form of a sampled value data stream via a connection 11. The protection tester 10 is coupled for synchronisation with the time source 9. The analogue currents and voltages are fed to the merging unit 7, which samples the currents and voltages and delivers them to the evaluation device 3 as a digitised SV data stream via the network TAP 2. The corresponding digital values from the protection tester 10 are likewise fed to the evaluation device 3. The protection tester 10 accordingly represents an ideal merging unit, which is synchronised with the same time source 9 as the real merging unit 7. By comparing the SV data stream from the protection tester 10 with the SV data stream from the merging unit 7, the accuracy of the merging unit 7 can be determined and evaluated. It is thereby possible to evaluate both the time behaviour of the merging unit 7 and the sampling accuracy and accordingly the quality of an analogue-digital conversion of the merging unit 7 by comparison with the reference data from the protection tester 10. Instead of the merging unit 7, any other intelligent electronic device suitable for sampling analogue data and producing an SV data stream can be used in FIG. 5, for example a merging unit.

### LIST OF REFERENCE NUMERALS

1 Device
2 Network access device (network TAP)
3 Evaluation device
4 Connection
5 Connection
   6 Monitoring connection
7 Network node (sampling unit, merging unit, SV sender)
8 Network node (SV receiver)
9 Time source
10 Protection tester
11 Connection digital values
12 Connection analogue currents/voltages
1000 Power plant
1001, 1002 Generators
1103 Circuit breaker
1111 Circuit breaker
1201, 1202 Power transformer
1211 Power transformer
1401 Bus-bar
1411 Bus-bar
1412 Bus-bar
1501, 1502 High-voltage transmission line
1600 Transformer plant
1701, 1702 Line
1903 Transformer, sensor
1911-1914 Transformer, sensor
1952 Transformer, sensor
1961 Transformer, sensor
1964 Transformer, sensor
1981-1984 Intelligent electronic device
1991-1994 Intelligent electronic device
2000 Dividing line
2001 Generator protection system (GS)
2002 Transformer differential protection system (TS)
2003 Line protection system (LS)
2011-2013 Line protection system (LS)
2012 Transformer differential protection system (TS)
2111 Communication network
2211 Communication network

1. Method for evaluating an electrical installation of an electrical power system, wherein the electrical installation comprises a communication network for transmitting data, wherein the method comprises:
automatic detection of real-time data transmissions in the communication network, and
automatic evaluation of the electrical installation on the basis of the detected real-time data transmissions.

2. Method according to claim 1, wherein the evaluation of the electrical installation comprises determining missing real-time data transmissions.

3. Method according to claim 1, wherein the real-time data transmissions are in each case detected automatically in at least two different locations of the communication network.

4. Method according to claim 1, wherein time-related information is automatically assigned to each of the detected real-time data transmissions, and
in that the communication network of the electrical installation is evaluated automatically on the basis of the time-related information of the detected real-time data transmissions.

5. Method according to claim 4, wherein the evaluation of the electrical installation comprises determining a statistical distribution of the real-time data transmissions in respect of their time-related information.

6. Method according to claim 4, wherein the evaluation of the electrical installation comprises determining a time interval between successive real-time data transmissions.

7. Method according to claim 1, wherein a sampling unit of the electrical installation forms a real-time sampled value by sampling an electrical parameter of the electrical power system and transmits it as a real-time data transmission via the communication network.

8. Method according to claim 7, wherein the sampling unit comprises a merging unit which is arranged to sample a plurality of real-time sampled values of a plurality of electrical parameters of the electrical power system and to transmit them as a real-time data transmission via the communication network.

9. Method according to claim 8, wherein the merging unit comprises a merging unit according to IEC 61850.

10. Method according to claim 9, wherein the sampling unit, the merging unit or a transmitting device of the sampling unit for transmitting the real-time sampled values is evaluated automatically on the basis of the detected real-time data transmissions.

11. Method according to claim 7, wherein time-related information is automatically assigned to each of the detected real-time data transmissions on leaving the sampling unit, and
wherein the sampling unit of the electrical installation is evaluated automatically on the basis of the time-related information of the detected real-time data transmissions.

12. Method according to claim 7, wherein the transmitted real-time data transmissions are detected by a network access device, wherein the sampling unit and the network access device are synchronised with a time source and the network access device assigns time-related information to each of the real-time data transmissions.

13. Method according to claim 12, comprising the provision of a reference signal which comprises reference time-related information,
wherein the sampling unit samples the reference signal and transmits it as a real-time data transmission via the communication network, and
wherein the electrical installation is evaluated automatically on the basis of a comparison of the reference time-related information with the time-related information of the real-time data transmission.

14. Method according to claim 13, wherein the reference signal comprises a reference value,
wherein the electrical installation is evaluated automatically on the basis of a comparison of real-time sampled values of the real-time data transmission with the reference value.

15. Method according to claim 13, wherein the reference signal is provided by a protection tester, wherein the protection tester simulates an ideal sampling unit, and wherein the protection tester and the sampling unit are synchronised with the time source.

16. Device for evaluating an electrical installation of an electrical power system, wherein the electrical installation comprises a communication network for transmitting data, wherein the device comprises:
a network access device which can be coupled with the communication network and is arranged to detect real-time data transmissions in the communication network, and
an evaluation device which is provided with the real-time data transmissions by the network access device and which is arranged to evaluate the electrical installation on the basis of the real-time data transmissions.

17. Device according to claim 16, wherein the electrical installation further comprises a sampling unit which is arranged to form a real-time sampled value by sampling an electrical parameter of the electrical power system and to transmit it as a real-time data transmission via the communication network.

18. Device according to claim 17, wherein the sampling unit comprises a merging unit which is arranged to sample a plurality of real-time sampled values of a plurality of electrical parameters of the electrical power system and to transmit them as a real-time data transmission via the communication network.

19. Device according to claim 18, wherein the merging unit comprises a merging unit according to IEC 61850.

20. Device according to claim 17, wherein the device further comprises a time source which is arranged to synchronise the sampling unit and the network access device.

21. Device according to claim 20, comprising a protection tester which is arranged to provide a reference signal comprising a reference value with associated reference time-related information,
wherein the sampling unit samples the reference signal and transmits it as a real-time data transmission via the communication network, and
wherein the electrical installation is evaluated automatically on the basis of a comparison of the reference time-related information with the time-related information of the real-time data transmission.

22. Device according to claim 21, wherein the protection tester simulates an ideal sampling unit, wherein the protection tester and the sampling unit are synchronised with the time source.
